(19) United States
(12) Patent Application Publication
(10) Pub. No.: US 2026/0211578 A1
(43) Pub. Date: Jul. 23, 2026

(54) METHOD OF OPERATING STORAGE CONTROLLER INCLUDING OFFLOADING ENGINE, STORAGE SYSTEM, AND METHOD OF OPERATING THE STORAGE SYSTEM

(71) Applicant: Samsung Electronics Co., Ltd., Suwon-si (KR)

(72) Inventors: Hyungon Moon, Ulsan (KR); Chanyoung Park, Ulsan (KR); Minu Chung, Ulsan (KR)

(73) Assignee: UNIST (Ulsan National Institute Of Science And Technology), Ulsan (KR)

(21) Appl. No.: 19/439,086

(22) Filed: Jan. 2, 2026

(30) Foreign Application Priority Data
Jan. 20, 2025 (KR) 10-2025-0008325
Jun. 16, 2025 (KR) 10-2025-0078898

(51) Int. Cl. G06F 3/06

(52) U.S. Cl. CPC G06F 3/0655; G06F 3/0604; G06F 3/0679

(57) ABSTRACT

The method includes receiving, by the offloading manager, a read offloading request for a workload with a data-dependent read pattern, transmitting, by the offloading manager, a first adaptive read request including metadata and a first address to the storage device based on the read offloading request, performing, by the storage device, a first read operation corresponding to the first address, determining, by the storage device, whether to perform a second offloading operation based on an internal resource, when it is determined by the storage device to perform the second offloading operation, generating a second address based on metadata and first read data, and performing a second read operation corresponding to the second address, and when it is determined by the storage device not to perform the second offloading operation, transmitting, to the offloading manager, a first response including a reverse offloading field indicating an activation value.

### CROSS-REFERENCE TO RELATED APPLICATIONS

This application is based on and claims priority under 35 U.S.C. § 119 to Korean Patent Application Nos. 10-2025-0008325, filed on Jan. 20, 2025, and 10-2025-0078898, filed on Jun. 16, 2025, in the Korean Intellectual Property Office, the disclosures of each of which are incorporated by reference herein in their entirety.

### BACKGROUND

Semiconductor memory is classified into volatile memory devices, such as static random access memory (SRAM) and dynamic RAM (DRAM), where stored data is destroyed when power supply thereto is cut off, and nonvolatile memory devices, such as flash memory devices, phase-change RAM (PRAM), magnetoresistive RAM (MRAM), resistive RAM (RRAM), and ferroelectric RAM (FRAM), where stored data is maintained even when power supply thereto is cut off.

Storage devices are an example of various electronic devices. A storage device may store and output data according to operations of components included therein, and thus may provide a storage service to a user. The storage device may manage data alone, or may manage data while communicating with other electronic devices.

A host device may be an electronic device that provides a service to a user by communicating with the storage device. The host device may transmit, to a storage device, data to be stored in the storage device. In addition, the host device may manage data to be stored in the storage device.

### SUMMARY

The present disclosure relates to a semiconductor memory, and more particularly, to a method of operating a storage controller including offloading engine, a storage system, and a method of operating the storage system.

Aspects of the present disclosure provide a method of operating a storage controller having improved performance, a storage system, and a method of operating the storage system.

According to an aspect of the present disclosure, there is provided a method of operating a storage system including a host device and a storage device, the host device including an offloading manager, the method including obtaining, by the offloading manager, a read offloading request for a workload with a data-dependent read pattern, transmitting, by the offloading manager, a first adaptive read request including metadata and a first address to the storage device based on the read offloading request, performing, by the storage device, a first read operation corresponding to the first address based on the first adaptive read request, determining, by the storage device, whether to perform a second offloading operation based on an internal resource, when it is determined by the storage device to perform the second offloading operation, generating a second address based on metadata and first read data that is a result of the first read operation, and performing a second read operation corresponding to the second address, and when it is determined by the storage device not to perform the second offloading operation, transmitting, to the offloading manager, a first response including an reverse offloading field indicating an activation value.

According to an aspect of the present disclosure, there is provided a method of operating a storage controller, the method including receiving an adaptive read request including a first address and an address of a host memory in which metadata is stored, reading metadata from the address of the host memory, transmitting a first read command corresponding to the first address to a nonvolatile memory device, receiving first read data corresponding to the first read command from the nonvolatile memory device, determining whether to perform a second offloading operation based on an internal resource, when it is determined to perform the second offloading operation, generating a second address based on metadata and the first read data and performing a second read operation corresponding to the second address, when it is determined not to perform the second offloading operation, transmitting, to a host device, a first response including an reverse offloading field indicating an activation value, and transmitting, to the host device, a second response including an reverse offloading field indicating a deactivation value and a version number field indicating a version number of metadata, wherein the first adaptive read request is an offloading request for a workload having a data-dependent read pattern.

According to an aspect of the present disclosure, there is provided a storage system including a host device that includes an offloading manager, and a storage device that includes a storage controller and a nonvolatile memory device, wherein the offloading manager is configured to obtain read offloading requests for workloads with data-dependent read patterns, and transmit a first adaptive read request including metadata and a first address to the storage device based on the read offloading request, and the storage controller is configured to perform a first read operation corresponding to the first address based on the first adaptive read request, determine whether to perform a second offloading operation based on an internal resource, when it is determined to perform the second offloading operation, generate a second address based on metadata and first read data that is a result of the first read operation, and perform a second read operation corresponding to the second address, and when it is determined not to perform the second offloading operation, transmit, to the offloading manager, a first response including a reverse offloading field indicating an activation value.

### BRIEF DESCRIPTION OF THE DRAWINGS

Implementations will be more clearly understood from the following detailed description taken in conjunction with the accompanying drawings in which:

FIG. 1 is a block diagram illustrating a storage system according to an implementation;

FIG. 2 is a diagram illustrating software layers of the storage system of FIG. 1 according to an implementation;

FIG. 3 is a block diagram illustrating in more detail the offloading manager and the offloading engine of FIG. 1 according to an implementation;

FIG. 4 is a flowchart illustrating an example of a method of operating the storage system of FIG. 1 according to an implementation;

FIGS. 5A to 5C are diagrams respectively illustrating examples of a method of operating the storage system of FIG. 1 according to an implementation;

FIG. 6 is a diagram illustrating metadata according to an implementation;

FIG. 7 is a flowchart illustrating an example of a method of operating the offloading manager of FIG. 1 according to an implementation;

FIG. 8 is a flowchart illustrating operation S580 of FIG. 7 in more detail according to an implementation;

FIG. 9 is a flowchart illustrating an example of a method of operating the storage controller of FIG. 1 according to an implementation;

FIG. 10 is a flowchart illustrating operation S604 of FIG. 9 in more detail according to an implementation;

FIG. 11A is a flowchart illustrating operation S604 of FIG. 9 in more detail according to an implementation;

FIG. 11B is a flowchart illustrating operation S640 of FIG. 11A in more detail according to an implementation;

FIG. 11C is a flowchart illustrating operation S650 of FIG. 11A in more detail according to an implementation;

FIGS. 12A and 12B are diagrams respectively illustrating operations of the storage system of FIG. 1 according to an implementation;

FIG. 13 is a flowchart illustrating an example of a method of operating the storage system of FIG. 1 according to an implementation;

FIG. 14 is a block diagram illustrating in more detail a workload analyzer, an offloading manager, and an offloading engine according to an implementation;

FIG. 15 is a flowchart illustrating an example of a method of operating the storage system of FIG. 1 according to an implementation; and

FIG. 16 is a diagram of a system according to an implementation.

### DETAILED DESCRIPTION

Hereinafter, implementations of the present disclosure will be described in clear and detail so that those skilled in the art may easily carry out the present disclosure.

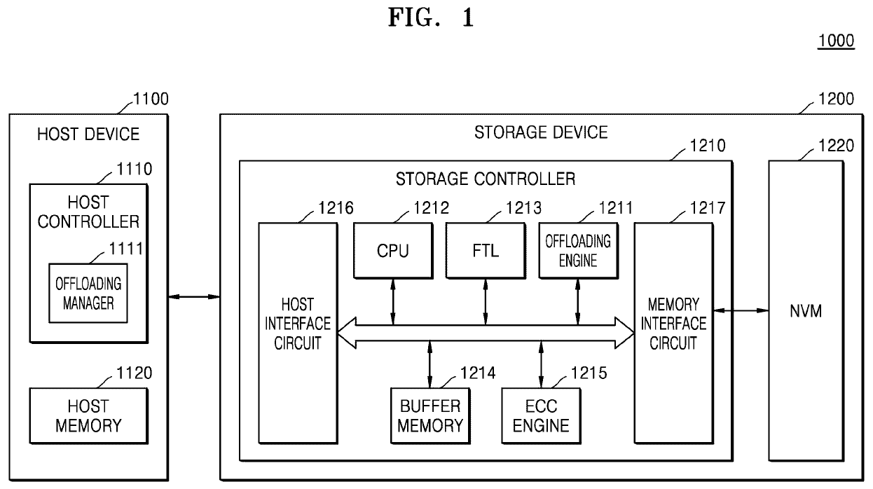

FIG. 1 is a block diagram illustrating a storage system according to an implementation.

Referring to FIG. 1, a storage system 1000 may include a host device 1100 and a storage device 1200. In some implementations, the storage device 1200 may include a storage controller 1210 and a nonvolatile memory device 1220. In some implementations, according to an implementation, the host device 1100 may include a host controller 1110 and a host memory 1120. The host memory 1120 may function as a buffer memory for temporarily storing data to be transmitted to the storage device 1200 or data received from the storage device 1200.

The storage device 1200 may include storage media for storing data according to a request from the host device 1100. For example, the storage device 1200 may include at least one of a solid state drive (SSD), an embedded memory, and a detachable external memory. When the storage device 1200 is an SSD, the storage device 1200 may be a device that complies with a nonvolatile memory express (NVMe) standard. When the storage device 1200 is an embedded memory or an external memory, the storage device 1200 may be a device that complies with a universal flash storage (UFS) or an embedded multi-media card (eMMC) standard. The host device 1100 and the storage device 1200 may generate packets and transmit the generated packets to each other according to the adopted standard protocols, respectively.

When the nonvolatile memory 1220 of the storage device 1200 includes a flash memory, the flash memory may include a two-dimensional (2D) NAND memory array or a three-dimensional (3D) (or vertical) NAND (VNAND) memory array. As another example, the storage device 1200 may include various other types of nonvolatile memories. For example, the storage device 1200 may employ magnetic random access memory (MRAM), spin-transfer torque MRAM, conductive bridging RAM (CBRAM), ferroelectric RAM (FeRAM), phase-change RAM (PRAM), resistive RAM, and other various types of memory.

According to an implementation, the host controller 1110 and the host memory 1120 may be implemented as separate semiconductor chips. Alternatively, in some implementations, the host controller 1110 and the host memory 1120 may be integrated into the same semiconductor chip. For example, the host controller 1110 may be any one of a plurality of modules provided in an application processor, and the application processor may be implemented as a system on chip (SoC). In some implementations, the host memory 1120 may be an embedded memory provided in the application processor, or a nonvolatile memory or memory module placed outside the application processor.

The host controller 1110 may manage an operation of storing data (e.g., write data) of the buffer area in the nonvolatile memory device 1220 or storing data (e.g., read data) of the nonvolatile memory device 1220 in the buffer area.

The storage controller 1210 may include an offloading engine 1211, a central processing unit (CPU) 1212, a flash translation layer (FTL) 1213, a buffer memory 1214, an error correction code (ECC) engine 1215, a host interface circuit 1216, and a memory interface circuit 1217. The storage controller 1210 may further include a working memory in which the FTL 1213 is loaded, and a data write operation and a data read operation with respect to the nonvolatile memory may be controlled by the CPU 1212 executing the FTL 1213.

The host interface circuit 1216 may transmit and receive packets to and from the host device 1100. A packet transmitted from the host device 1100 to the host interface circuit 1216 may include a command or data to be recorded in the nonvolatile memory device 1220, and a packet transmitted from the host interface circuit 1216 to the host device 1100 may include a response to the command or data read from the nonvolatile memory device 1220. The memory interface circuit 1217 may transmit write data to the nonvolatile memory device 1220 or receive read data from the nonvolatile memory device 1220. The memory interface circuit 1217 may be implemented to comply with standard protocols such as toggle or open NAND flash interface (ONFI).

The FTL 1213 may perform various functions such as address mapping, wear-leveling, and garbage collection. The address mapping operation is an operation of converting a logical address received from the host into a physical address used to actually store data in the nonvolatile memory device 1220. The wear-leveling is technology for preventing excessive deterioration of a specific block by uniformly using blocks in the nonvolatile memory device 1220, and may be implemented through firmware technology that balances erase counts of physical blocks, for example. The garbage collection is a technology for securing usable capacity in the nonvolatile memory device 1220 by erasing the existing block after copying the effective data of the block to a new block.

The ECC engine 1215 may perform an error detection and correction function on read data read from the nonvolatile memory device 1220. The ECC engine 1215 may perform an error detection operation and an error correction operation. The ECC engine 1215 may perform an error detection operation to determine whether an error exists in data.

The storage controller 1210 may communicate with the nonvolatile memory device 1220 through a plurality of channels. The nonvolatile memory device 1220 may store data or output the stored data under the control by the storage controller 1210. The nonvolatile memory device 1220 may include a plurality of nonvolatile memories NVM.

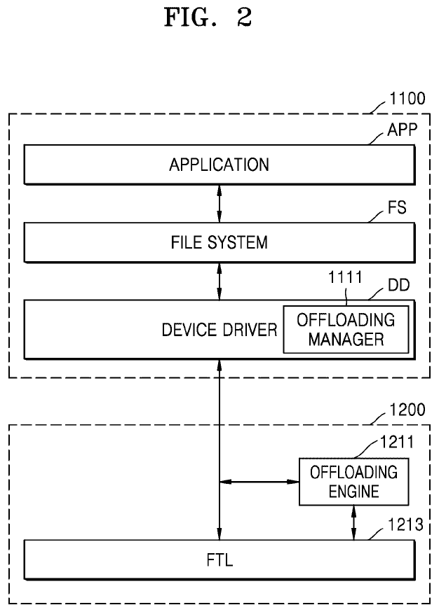

The storage system 1000 may offload the operation of the application (APP of FIG. 2) to the storage device 1200 or an offloading manager 1111. The storage device 1200 or the offloading manager 1111 may perform an operation instead of the application APP. An operation of a workload having a data-dependent read pattern may be performed within the storage device 1200 or in a kernel space. The workload of the host device 1100 may be improved.

The offloading manager 1111 and the storage controller 1210 may perform an offloading operation through an extended Berkeley Packet Filter (eBPF). The offloading manager 1111 and the storage controller 1210 may receive read offloading program instructions. The offloading manager 1111 and the storage controller 1210 may load and execute read offloading program instructions. The read offloading program instructions may be in the format of an eBPF program, but implementations are not limited thereto. Program instructions may be implemented in different formats, such as, for example, other types of machine language code, byte code, or program format that may be executed by the offloading manager 1111 and the storage controller 1210.

The storage system 1000 may perform a hybrid read offloading operation (hereinafter referred to as a read offloading operation). The read offloading operation according to an implementation may indicate an operation in which at least one of the offloading manager 1111 of the kernel space and the storage device 1200 performs an operation to be processed by the application APP. In other words, the read offloading operation may refer to an operation of offloading an operation to be processed by the application APP to the offloading manager 1111 or the storage device 1200 and distributing and performing the operation. The read offloading operation may refer to an operation in which the storage device 1200 preferentially performs an offloading operation, and when operation resources are insufficient, the offloading manager 1111 of the kernel space performs an offloading operation.

The storage system 1000 may more efficiently process a workload having a data-dependent read pattern through the read offloading operation. For example, a data-dependent read pattern may include, at least two times, read operations for the storage device, and a subsequent read operation may refer to an operation performed by referring to the result of the preceding read operation. For example, workloads with data-dependent read patterns may include database query processing, key-value stores, log-structured merge trees (LSM trees), B tree-based search, and the like.

The host controller 1110 may include the offloading manager 1111. The offloading manager 1111 may receive a read offloading request. For example, the read offloading request may be a request indicating a first offloading operation performed by the offloading manager 1111 in the kernel space or a second offloading operation performed by the storage device 1200. In an implementation, the read offloading request may be a read offloading request for a workload having a data-dependent read pattern.

In one implementation, the offloading operation may be a hybrid re-submission operation. The re-submission operation may refer to a data-dependent read operation that performs a subsequent read operation based on a result of the previous read operation. In oetrh words, the offloading operation according to an implementation may indicate calculating a logical address of the second read operation based on read data corresponding to the first read operation. Here, the second read operation may refer to a read operation to be performed after the first read operation. Alternatively, the offloading operation may refer to an operation of calculating a file offset based on read data corresponding to the first read operation and converting the file offset into a logical address based on metadata.

In an implementation, the offloading operation may include a first offloading operation and a second offloading operation. The first offloading operation may indicate an offloading operation performed in the kernel space (or the offloading manager 1111). The second offloading operation may indicate an offloading operation performed by the storage device 1200.

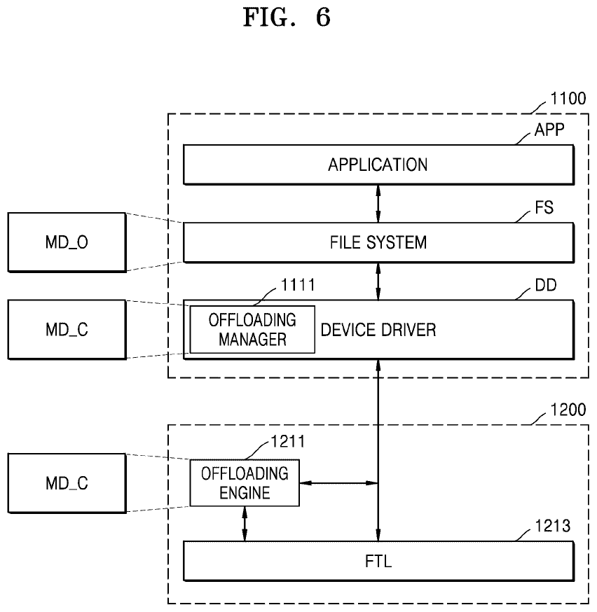

In an implementation, the offloading manager 1111 may generate metadata MD_C by copying metadata MD_O of a file system FS (see FIG. 6). The metadata MD_C may include mapping information between a file offset and a logical address. The offloading manager 1111 may transmit the metadata MD_C to the storage device 1200.

In an implementation, the offloading manager 1111 may transmit an adaptive read request to the storage device 1200. For example, the adaptive read request may be a request to perform a second offloading operation when resources are sufficient and to instruct to perform reverse offloading when resources are insufficient. In an implementation, the adaptive read request may be an offloading request for a workload having a data-dependent read pattern.

In an implementation, the offloading manager 1111 may perform the first offloading operation. The offloading manager 1111 may perform a first offloading operation for performing an operation offloaded in the application APP. For example, the offloading manager 1111 may perform the first offloading operation based on the reverse offloading request received from the storage device 1200.

In an implementation, the offloading manager 1111 may perform a validation operation. In order to ensure the validity of the metadata MD_C while the offloading manager 1111 performs the read offloading operation, a validation operation may be performed. For example, the offloading manager 1111 may determine whether the version number of the metadata MD_C is the same as the version number of the metadata MD_O of the file system FS.

In an implementation, the offloading engine 1211 may receive an adaptive read request from the host device 1100. The offloading engine 1211 may determine whether to perform the second offloading operation. The offloading engine 1211 may perform the second offloading operation. The offloading engine 1211 may perform a second offloading operation for performing an operation offloaded in the application APP. For example, the second offloading operation may indicate on-device execution.

In an implementation, the offloading engine 1211 may receive the metadata MD_C from the host device 1100. The offloading engine 1211 may read the metadata MD_C from the host memory 1120. The offloading engine 1211 may manage the metadata MD_C. The offloading engine 1211 may cache and use the metadata MD_C. The offloading engine 1211 may perform a second offloading operation based on the metadata MD_C.

In an implementation, the offloading engine 1211 may perform reverse offloading. The reverse offloading may indicate an operation of requesting that the first offloading operation is performed in the kernel space. For example, the offloading engine 1211 may perform reverse offloading when a CPU 1212 (or a core or processor) is in use and the operation latency of the second offloading operation is predicted to be longer than the transmission latency between the host device 1100 and the storage device 1200.

In an implementation, the offloading engine 1211 may perform a second offloading operation in parallel. The offloading engine 1211 may perform a parallel second offloading operation. In order to reduce latency, the offloading engine 1211 may have a plurality of cores performing a second offloading operation in parallel.

As described above, the storage system 1000 may perform a read offloading operation. The offloading manager 1111 may perform a first offloading operation, and the storage device 1200 may perform a second offloading operation. Accordingly, the operation load of the host device 1100 may be distributed and latency may be reduced. In some implementations, when internal resources of the storage device 1200 are insufficient, reverse offloading may be performed to prevent an increase in latency. Accordingly, the storage system 1000 with improved performance is provided.

The offloading manager 1111 may have the form of hardware, software, or a combination thereof configured to manage the operations described above. The offloading engine 1211 may have the form of hardware, software, or a combination thereof configured to manage the operations described above. Operations of the offloading manager 1111 and the offloading engine 1211 will be described in more detail with reference to the following drawings.

FIG. 2 is a diagram illustrating software layers of the storage system of FIG. 1 according to an implementation.

Referring to FIGS. 1 and 2, the software layer of the storage system 1000 may include an application APP, a file system FS, a device driver DD, an offloading engine 1211, and an FTL 1213. The host device 1100 may include the application APP, the file system FS, and the device driver DD. The device driver DD may include an offloading manager 1111. The storage device 1200 may include the offloading engine 1211 and the FTL 1213. For convenience of description, detailed descriptions of the components described above are omitted.

In an implementation, the software layer of the host device 1100 may include a user space and a kernel space. The user space may be a space in which an application is executed, and the kernel space may be a restrictively reserved space for kernel execution. In order to gain access to the kernel space in the user space, a system call may be used. The user space may include an application APP. The kernel space may include the file system FS, the device driver DD, the offloading manager 1111, and the like.

The application APP may include various application programs driven in the host device 1100. The application APP may include a plurality of applications. The application APP may transmit a read offloading request to the offloading manager 1111. The application APP may transmit a parallel read offloading request to the offloading manager 1111.

The file system FS may be configured to organize files or data used by the application APP. For example, the file system FS may manage the storage space of the storage device 1200 as a logical block address (LBA) (hereinafter referred to as a logical address). The file system FS may assign and manage logical addresses to data stored in the storage device 1200.

In an implementation, the file system FS may have a different form depending on the operating system of the host device 1100. The file system FS may include at least one of various file system forms, such as File Allocation Table (FAT), FAT32, NT File System (NTFS), Hierarchical File System (HFS), Journaled File System2 (JFS2), XFS, On-Disk Structure-5 (ODS-5), UDF, ZFS, Unix File System (UFS), ext2, ext3, ext4, ReiserFS, Reiser4, ISO 9660, Gnome VFS, BFS, WinFS, etc.

The device driver DD may perform an operation of converting information from the file system FS or the application APP into information recognizable in the storage device 1200. In an implementation, the application APP, the file system FS, the device driver DD, and the offloading manager 1111 may be implemented in the form of software and may be driven on the host device 1100.

The offloading manager 1111 may receive a read offloading request. The offloading manager 1111 may process a read offloading request. The offloading manager 1111 may transmit an adaptive read request to the storage device 1200. The offloading manager 1111 may perform the first offloading operation based on the reverse offloading request (or a response including an reverse offloading field indicating an activation value).

The offloading engine 1211 may receive the adaptive read offloading request. The offloading engine 1211 may process the adaptive read offloading request. The offloading engine 1211 may transmit an reverse offloading request to the offloading manager 1111. The offloading engine 1211 may perform the second offloading operation.

The FTL 1213 may be configured to convert a logical address of a request received from the host device 1100 into a physical block address (or a physical address) used in the nonvolatile memory device 1220.

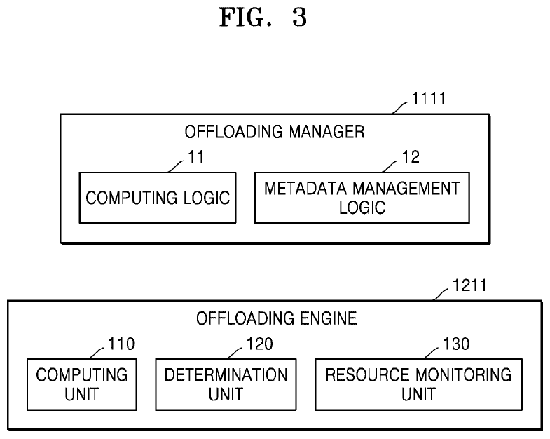

FIG. 3 is a block diagram illustrating in more detail the offloading manager and the offloading engine of FIG. 1 according to an implementation.

Referring to FIGS. 1 and 3, the offloading manager 1111 may include a computing logic 11 and a metadata management logic 12. The offloading engine 1211 may include a computing unit 110, a determination unit 120, and a resource monitoring unit 130.

The computing logic 11 may perform a first offloading operation. The computing logic 11 may calculate a file offset based on first read data RD1. The computing logic 11 may convert the file offset into a logical address based on the metadata MD_C.

The metadata management logic 12 may manage the metadata MD_C. The metadata management logic 12 may generate the metadata MD_C by copying the metadata MD_O of the file system FS. The metadata management logic 12 may perform a validation operation.

The computing unit 110 may perform a second offloading operation. The computing unit 110 may calculate a file offset based on the first read data RD1. The computing unit 110 may convert the file offset into a logical address based on the metadata MD_C.

The determination unit 120 may receive an internal resource state from the resource monitoring unit 130. The determination unit 120 may determine whether to perform the second offloading operation based on the internal resource state. For example, the internal resource state may include an operation resource state. The determination unit 120 may determine to perform the second offloading operation when the operation resource is sufficient, and may determine to perform the reverse offloading when the operation resource is insufficient.

The resource monitoring unit 130 may monitor the internal resource state. The resource monitoring unit 130 may periodically check the state of the CPU 1212 (for example, the core or processor). For example, the CPU 1212 may include a plurality of cores. The resource monitoring unit 130 may monitor states of the plurality of cores. The resource monitoring unit 130 may monitor utilization rates or loads of a plurality of cores. The resource monitoring unit 130 may provide the internal resource state to the determining unit 120.

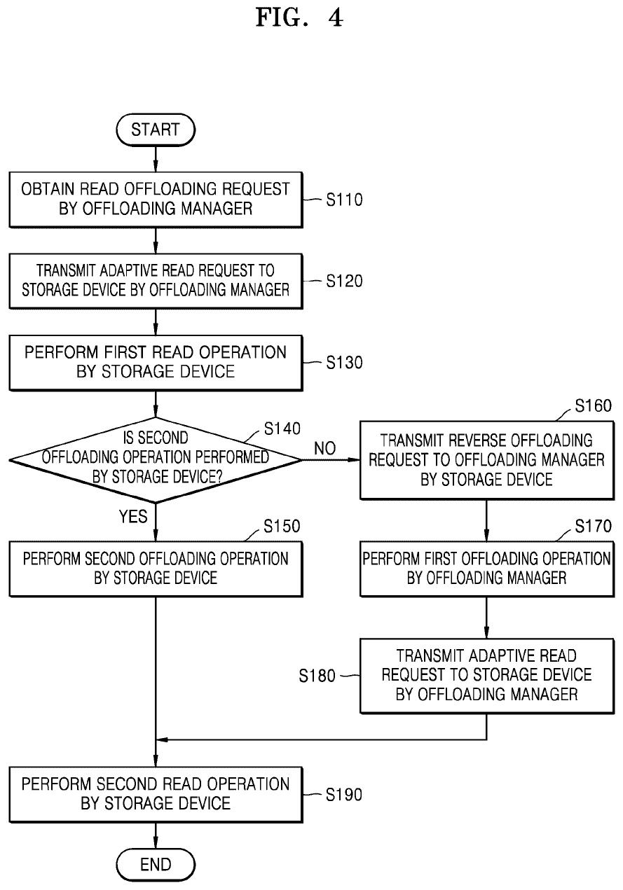

FIG. 4 is a flowchart illustrating an example of a method of operating the storage system of FIG. 1 according to an implementation.

Referring to FIGS. 1, 2, and 4, the storage system 1000 may perform a read offloading operation. In operation S110, the offloading manager 1111 may obtain a read offloading request R_OFF_REQ. The application APP may transmit the read offloading request R_OFF_REQ to the offloading manager 1111. In an implementation, the application APP may transmit the read offloading request R_OFF_REQ to the offloading manager 1111 by using a system call. The read offloading request R_OFF_REQ may be a type of system call. For example, the read offloading request R_OFF_REQ may be read_sode(). The offloading manager 1111 may receive a read offloading request R_OFF_REQ.

In operation S120, the offloading manager 1111 may transmit an adaptive read request to the storage device 1200. The offloading manager 1111 may transmit, to the storage device 1200, a first adaptive read request A_READ1 including a first address ADDR1. The offloading manager 1111 may fetch metadata corresponding to the read offloading request R_OFF_REQ from the file system FS. In an implementation, the offloading manager 1111 may generate the metadata MD_C (i.e., a metadata copy) by copying the metadata MD_O (i.e., a metadata original) of the file system FS.

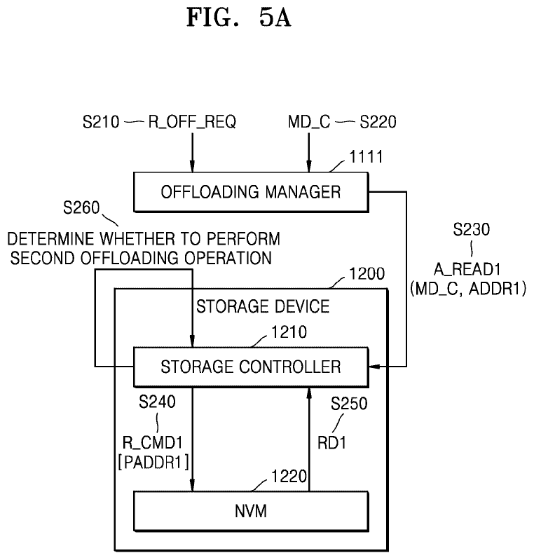

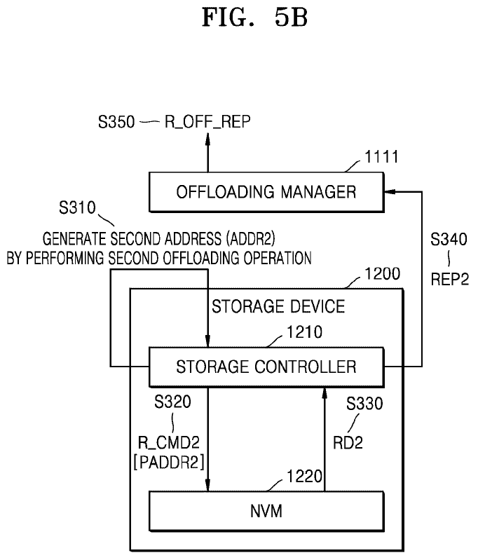

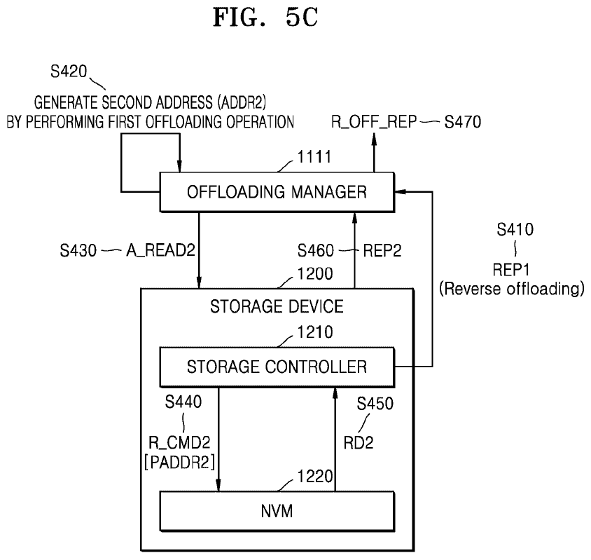

The offloading manager 1111 may transmit, to the storage device 1200, a first adaptive read request A_READ1 corresponding to the read offloading request R_OFF_REQ. For example, the first adaptive read request A_READ1 may include a first address ADDR1 provided from the file system FS and metadata MD_C. Alternatively, the first adaptive read request A_READ1 may include a first address ADDR1 and an address of the host memory 1120 in which the metadata MD_C is stored. The first address ADDR1 may indicate a logical address corresponding to the read offloading request R_OFF_REQ. The storage device 1200 may receive the first adaptive read request A_READ1 and the metadata MD_C (see FIG. 5A).

In operation S130, the storage device 1200 may perform a first read operation. The storage device 1200 may perform a first read operation in response to the first adaptive read request A_READ1. For example, the storage controller 1210 may transmit a first read command R_CMD1 corresponding to the first adaptive read request A_READ1 to the nonvolatile memory device 1220. The storage controller 1210 may convert the first address ADDR1 to the first physical address PADDR1. The first read command R_CMD1 may include a first physical address PADDR1 corresponding to the first address ADDR1. The nonvolatile memory device 1220 may transmit, to the storage controller 1210, first read data RD1 corresponding to the first physical address PADDR1 (or the first address ADDR1).

In operation S140, the storage device 1200 may determine whether to perform the second offloading operation. The storage device 1200 may determine whether to perform the second offloading operation based on the internal resource. For example, the internal resource may include an operation resource. In an implementation, the storage device 1200 may determine not to perform the second offloading operation when the latency is expected to increase when performing the second offloading operation.

For example, the storage device 1200 may determine whether a processor exists in an idle state. When there is a processor in a standby state, the storage device 1200 may determine to perform the second offloading operation. When it is determined to perform the second offloading operation, the storage system 1000 may perform the operation S150, and when it is determined not to perform the second offloading operation (i.e., when it is determined to perform the first offloading operation or when it is determined to perform the reverse offloading), the storage system 1000 may perform the operation of operation S160.

In operation S150, the storage device 1200 may perform a second offloading operation. The storage device 1200 may perform a second offloading operation based on the metadata MD_C and the first read data RD1. For example, the storage device 1200 may calculate a file offset based on the first read data RD1. The storage device 1200 may convert the file offset into a logical address based on the metadata MD_C. The storage device 1200 may generate a second address ADDR2. For example, the second address ADDR2 may indicate a logical address of a subsequent read operation, which is generated by referring to read data corresponding to the preceding read operation. After operation S150, the storage system 1000 may perform an operation of operation S190.

In operation S160, the storage device 1200 may transmit a reverse offloading request to the offloading manager 1111. The storage device 1200 may transmit, to the offloading manager 1111, a first response REP1 including a reverse offloading request and first read data RD1 (see FIG. 5C). For example, the storage device 1200 may transmit the first read data RD1 to the host memory 1120. The storage device 1200 may transmit, to the host device 1100, a first response REP1 including a reverse offloading field indicating an activation value. The first response REP1 may be a response corresponding to the first adaptive read request A_READ1.

In an implementation, when reverse offloading is requested, the storage device 1200 may transmit, to the host device 1100, a response including a reverse offloading field indicating an activation value. When the reverse offloading request is not made, the storage device 1200 may transmit, to the host device 1100, a response including a reverse offloading field indicating a deactivation value.

In operation S170, the offloading manager 1111 may perform the first offloading operation. The offloading manager 1111 may perform the first offloading operation based on the metadata MD_C and the first read data RD1. For example, the offloading manager 1111 may calculate a file offset based on the first read data RD1. The offloading manager 1111 may convert the file offset into a logical address based on the metadata MD_C. The offloading manager 1111 may generate a second address ADDR2.

In operation S180, the offloading manager 1111 may transmit an adaptive read request to the storage device 1200. The offloading manager 1111 may transmit, to the storage device 1200, a second adaptive read request A_READ2 including a second address ADDR2. For example, the second adaptive read request A_READ2 may further include an address of the host memory 1120 in which the metadata MD_C is stored. After operation S180, the storage system 1000 may perform an operation of operation S190.

In operation S190, the storage device 1200 may perform a second read operation. When the first offloading operation is performed, the storage device 1200 may perform a second read operation corresponding to the second address ADDR2 based on the second adaptive read request A_READ2. The storage device 1200 may perform a second read operation based on the second address ADDR2 included in the second adaptive read request A_READ2. When the second offloading operation is performed, the storage device 1200 may perform the second read operation based on the second address ADDR2 calculated by the storage device 1200.

In an implementation, the storage controller 1210 may convert the second address ADDR2 into a second physical address PADDR2. The storage controller 1210 may transmit, to the nonvolatile memory device 1220, a second read command R_CMD2 including a second physical address PADDR2 (see FIG. 5B). The nonvolatile memory device 1220 may transmit, to the storage controller 1210, the second read data RD2 corresponding to the second physical address PADDR2.

In an implementation, the storage controller 1210 may transmit the second read data RD2 and the second response REP2 to the host device 1100. The storage controller 1210 may transmit, to the host device 1100, a second response REP2 including a reverse offloading field indicating an inactivation value.

FIGS. 5A to 5C are diagrams respectively illustrating examples of a method of operating the storage system of FIG. 1 according to an implementation.

Referring to FIGS. 1, 5A, 5B, and 5C, the storage system 1000 may perform a read offloading operation. In operation S210, the offloading manager 1111 may obtain a read offloading request R_OFF_REQ. For example, the application APP may transmit the read offloading request R_OFF_REQ to the offloading manager 1111 by using a system call.

In operation S220, the offloading manager 1111 may fetch the metadata MD_C. The offloading manager 1111 may obtain the metadata MD_C corresponding to the read offloading request R_OFF_REQ. For example, the offloading manager 1111 may copy the metadata MD_O managed in the file system FS. The offloading manager 1111 may generate the same metadata MD_C as the metadata MD_O managed in the file system FS. For example, the metadata MD_O and the metadata MD_C may be stored in the host memory 1120.

In operation S230, the offloading manager 1111 may transmit the first adaptive read request A_READ1 to the storage device 1200. In an implementation, the first adaptive read request A_READ1 may be a command supported by the NVMe standard. The command may include an operational code (opcode) field. The operation code field may indicate an operation code of a command to be executed. The operation code of the first adaptive read request A_READ1 may indicate an adaptive read request (e.g., 0x80). The first adaptive read request A_READ1 may further include a version number field indicating the version number of the metadata MD_C.

For example, the first adaptive read request A_READ1 may include a first address ADDR1. The first address ADDR1 may correspond to the read offloading request R_OFF_REQ. The first address ADDR1 may indicate a logical address to be first accessed according to the read offloading request R_OFF_REQ. The first address ADDR1 may be included in the read offloading request R_OFF_REQ. Alternatively, the first address ADDR1 may be provided from the file system FS.

For example, the first adaptive read request A_READ1 may include metadata MD_C. Alternatively, the first adaptive read request A_READ1 may include an address of the host memory 1120 in which the metadata MD_C is stored. The offloading manager 1111 may transmit the first address ADDR1 and the metadata MD_C to the storage controller 1210.

In an implementation, the storage controller 1210 may receive the first adaptive read request A_READ1. The storage controller 1210 may receive the first address ADDR1 and the metadata MD_C.

In operation S240, the storage controller 1210 may transmit the first read command R_CMD1 to the nonvolatile memory device 1220. The storage controller 1210 may transmit, to the nonvolatile memory device 1220, a first read command R_CMD1 in response to the first adaptive read request A_READ1. The storage controller 1210 may convert the first address ADDR1 to the first physical address PADDR1. The storage controller 1210 may transmit, to the nonvolatile memory device 1220, a first read command R_CMD1 including a first physical address PADDR1.

The logical address may indicate an LBA managed by the host device 1100. The file system FS of the host device 1100 may recognize or manage the storage space of the storage device 1200 as a logical address. For example, the logical address may be used to access the storage space of the storage device 1200 in units of blocks or pages.

The physical address may indicate an actual physical address of the nonvolatile memory device 1220 managed by the storage controller 1210. The storage controller 1210 may recognize or manage the storage space of the nonvolatile memory device 1220 as a physical address. For example, the physical address may be used to access the storage space of the nonvolatile memory device 1220 in units of pages.

In operation S250, the nonvolatile memory device 1220 may transmit the first read data RD1 to the storage controller 1210. The nonvolatile memory device 1220 may receive the first read command R_CMD1. The nonvolatile memory device 1220 may read the first read data RD1 corresponding to the first physical address PADDR1 in response to the first read command R_CMD1. The nonvolatile memory device 1220 may transmit the first read data RD1 to the storage controller 1210.

In operation S260, the storage controller 1210 may determine whether to perform the second offloading operation. The storage controller 1210 may determine whether to perform the second offloading operation based on the state of an internal resource (e.g., an operation resource). The storage controller 1210 may determine to perform the second offloading operation when internal resources are sufficient. The storage controller 1210 may determine to perform the first offloading operation when internal resources are insufficient. When it is determined to perform the second offloading operation, the storage system 1000 may perform operations S310 to S350. When it is determined to perform the first offloading operation, the storage system 1000 may perform operations S410 to S470.

In operation S310, the storage controller 1210 may generate a second address ADDR2 by performing a second offloading operation. The storage controller 1210 may calculate a file offset based on the first read data RD1. The storage controller 1210 may convert the file offset into the second address ADDR2 based on the metadata MD_C.

In operation S320, the storage controller 1210 may transmit the second read command R_CMD2 to the nonvolatile memory device 1220. The storage controller 1210 may transmit the second read command R_CMD2 to the nonvolatile memory device 1220 based on the second address ADDR2 generated through the second offloading operation. The storage controller 1210 may convert the second address ADDR2 to the second physical address PADDR2. The storage controller 1210 may transmit, to the nonvolatile memory device 1220, a second read command R_CMD2 including a second physical address PADDR2.

In operation S330, the nonvolatile memory device 1220 may transmit the second read data RD2 to the storage controller 1210. The nonvolatile memory device 1220 may receive the second read command R_CMD2. The nonvolatile memory device 1220 may read the second read data RD2 corresponding to the second physical address PADDR2 in response to the second read command R_CMD2. The nonvolatile memory device 1220 may transmit the second read data RD2 to the storage controller 1210.

In operation S340, the storage controller 1210 may transmit a second response REP2 to the offloading manager 1111. For example, the second response REP2 may include a reverse offloading field indicating a deactivation value. The second response REP2 may include a version number field indicating the version number included in the first adaptive read request A_READ1. Alternatively, the second response REP2 may include a version number field indicating a version number corresponding to the metadata MD_C.

The storage controller 1210 may write the second read data RD2 to a data page address included in the first read adaptive request A_READ1. The data page address may indicate an address of the host memory 1120. The storage controller 1210 may transmit the second read data RD2 and the second response REP2 to the host device 1100.

In operation S350, the offloading manager 1111 may transmit the read offloading response R_OFF_REP to the application APP. The offloading manager 1111 may receive the second response REP2 from the storage device 1200. The offloading manager 1111 may perform a validation operation based on the second response REP2. The offloading manager 1111 may determine whether the version number field included in the second response REP2 is the same as the version number of the metadata MD_O of the file system FS. When the offloading manager 1111 passes the validation operation, the offloading manager 1111 may determine that the second read data RD2 is valid and transmit the read offloading response R_OFF_REP to the application APP.

In FIG. 5B, an example of transmitting a second response REP2 (or read offloading response R_OFF_REP) indicating that the read offloading has ended after the second offloading operation is performed once is illustrated, but implementations are not limited thereto. When additional reading is required even after receiving the second read data RD2, the storage system 1000 may determine again whether to perform the second offloading operation, and accordingly, the first offloading operation or the second offloading operation may be additionally performed. For example, it is shown that the second offloading operation is performed only once for the simplicity of the drawing, but in reality, the first offloading operation or the second offloading operation may be performed multiple times before the second response REP2 (or the read offloading response R_OFF_REP) is transmitted.

In operation S410, the storage controller 1210 may transmit a first response REP1 to the offloading manager 1111. For example, the first response REP1 may include a reverse offloading field indicating an activation value. The storage controller 1210 may write the first read data RD1 to a data page address included in the first read adaptive request A_READ1. The data page address may indicate an address of the host memory 1120. The storage controller 1210 may transmit the first read data RD1 and the first response REP1 to the host device 1100.

In operation S420, the offloading manager 1111 may generate the second address ADDR2 by performing the first offloading operation. In response to the first response REP1 including a reverse offloading field indicating an activation value, the offloading manager 1111 may calculate a file offset based on the first read data RD1. The storage controller 1210 may convert the file offset into the second address ADDR2 based on the metadata MD_C.

In operation S430, the offloading manager 1111 may transmit the second adaptive read request A_READ2 to the storage device 1200. For example, the second adaptive read request A_READ2 may include a second address ADDR2. For example, the offloading manager 1111 may transmit the metadata MD_C to the storage device 1200.

In operation S440, the storage controller 1210 may transmit the second read command R_CMD2 to the nonvolatile memory device 1220. The storage controller 1210 may receive a second adaptive read request A_READ2 including a second address ADDR2. The storage controller 1210 may transmit, to the nonvolatile memory device 1220, a second read command R_CMD2 corresponding to the second address ADDR2, based on the second adaptive read request A_READ2. The storage controller 1210 may transmit the second read command R_CMD2 to the nonvolatile memory device 1220 based on the second address ADDR2 generated through the first offloading operation. The storage controller 1210 may convert the second address ADDR2 to the second physical address PADDR2. The storage controller 1210 may transmit, to the nonvolatile memory device 1220, a second read command R_CMD2 including a second physical address PADDR2 (see FIG. 5B).

In operation S450, the nonvolatile memory device 1220 may transmit the second read data RD2 to the storage controller 1210. The nonvolatile memory device 1220 may receive the second read command R_CMD2. The nonvolatile memory device 1220 may read the second read data RD2 corresponding to the second physical address PADDR2 in response to the second read command R_CMD2. The nonvolatile memory device 1220 may transmit the second read data RD2 to the storage controller 1210.

In operation S460, the storage controller 1210 may transmit a second response REP2 to the offloading manager 1111. For example, the second response REP2 may include a reverse offloading field indicating a deactivation value. The storage controller 1210 may transmit the second read data RD2 and the second response REP2 to the host device 1100.

In operation S470, the offloading manager 1111 may transmit the read offloading response R_OFF_REP to the application APP. The offloading manager 1111 may receive the second response REP2 from the storage device 1200. The offloading manager 1111 may perform a validation operation based on the second response REP2. When the offloading manager 1111 passes the validation operation, the offloading manager 1111 may transmit the read offloading response R_OFF_REP to the application APP.

In FIG. 5C, an example of transmitting a second response REP2 (or read offloading response R_OFF_REP) indicating that the read offloading has ended after the first offloading operation is performed once is illustrated, but implementations are not limited thereto. When additional reading is required even after receiving the second read data RD2, the storage system 1000 may determine again whether to perform the second offloading operation, and accordingly, the first offloading operation or the second offloading operation may be additionally performed. For example, it is shown that the first offloading operation is performed only once for the simplicity of the drawing, but in reality, the first offloading operation or the second offloading operation may be performed multiple times before the second response REP2 (or the read offloading response R_OFF_REP) is transmitted.

FIG. 6 is a diagram illustrating metadata according to an implementation.

Referring to FIGS. 1 and 6, the offloading manager 1111 and the offloading engine 1211 may directly convert a file offset into a logical address based on the metadata MD_C instead of the file system FS. The offloading manager 1111 may generate the metadata MD_C by copying the metadata MD_O managed by the file system FS. The offloading manager 1111 may transmit the metadata MD_C to the offloading engine 1211. The offloading manager 1111 and the offloading engine 1211 may convert the file offset into a logical address based on the metadata MD_C.

In an implementation, the metadata MD_C may include an extent status tree and a version number. The extent status tree may be used when converting a file offset into a logical address. The version number may indicate a version number of an extent status tree corresponding to a corresponding file when the metadata MD_C is generated. The version number may be used for a validation operation. The version number may change whenever the file is updated. For example, the file system FS may update the version number whenever the extent state tree is updated. In an implementation, the metadata MD_C may further include the number of range tree nodes.

In an implementation, the offloading operation is mainly performed on a read-only file (READ ONLY FILE), and most of these files may remain unchanged. Accordingly, the offloading engine 1211 may perform a second offloading operation based on the cached metadata MD_C.

The offloading engine 1211 may perform a second offloading operation based on the cached metadata MD_C. The offloading engine 1211 may predict that the file has not been changed and preferentially perform a second offloading operation. In other words, although the metadata MD_C may be different from the metadata MD_O of the current file system FS, the offloading engine 1211 may first perform the second offloading operation based on the metadata MD_C. For example, the offloading engine 1211 may perform the second offloading operation according to an optimistic approach. The offloading engine 1211 may trust a validation operation to be performed by the offloading manager 1111, and may first perform a second offloading operation.

The offloading engine 1211 may transmit a response including the version number to the offloading manager 1111. Here, the response may indicate a response corresponding to the adaptive read request. The version number included in the response may be used in the validation operation.

The offloading manager 1111 may perform a validation operation. The validation operation may refer to an operation of checking data consistency. In an implementation, the validation operation may indicate an operation of verifying data consistency by comparing the metadata MD_C with the metadata MD_O stored in the file system FS. Since the metadata MD_C is a copy of the metadata MD_O of the file system FS, when the file system FS changes the file, the metadata MD_O may be updated. The offloading manager 1111 may verify whether the metadata MD_C is valid by checking whether the metadata MD_O is changed through a validation operation. Accordingly, the offloading manager 1111 may verify whether the result of the read offloading operation is valid.

The offloading manager 1111 may determine whether the metadata MD_O is the same as the metadata MD_C based on the version number included in the metadata MD_O and the version number included in the metadata MD_C. The offloading manager 1111 may compare the version number included in the metadata MD_O with the version number included in the metadata MD_C. When the version number included in the metadata MD_O is the same as the version number included in the metadata MD_C, the offloading manager 1111 may determine that the metadata MD_O is the same as the metadata MD_C. When the version number included in the metadata MD_O is different from the version number included in the metadata MD_C, the offloading manager 1111 may determine that the metadata MD_O is different from the metadata MD_C.

As described above, the offloading manager 1111 may copy metadata of the file system FS required for address conversion. The offloading manager 1111 may generate the metadata MD_C by copying the metadata MD_O of the file system FS. The offloading manager 1111 may transmit the metadata MD_C to the storage device 1200. The offloading manager 1111 may perform a first offloading operation based on the metadata MD_C, and the offloading engine 1211 may perform a second offloading operation based on the metadata MD_C. The offloading manager 1111 or the offloading engine 1211 may not access the metadata MD_O of the file system FS during the first offloading operation or the second offloading operation. Accordingly, the storage system 1000 may reduce latency and improve performance.

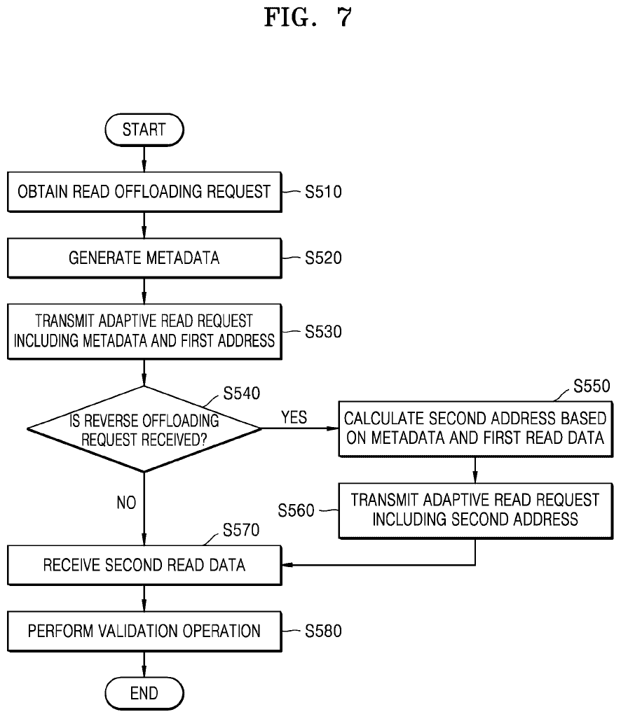

FIG. 7 is a flowchart illustrating an example of a method of operating the offloading manager of FIG. 1 according to an implementation.

Referring to FIGS. 1 and 7, the offloading manager 1111 may process a read offloading request and perform a first offloading operation. In operation S510, the offloading manager 1111 may obtain a read offloading request R_OFF_REQ.

In operation S520, the offloading manager 1111 may generate the metadata MD_C. The offloading manager 1111 may generate the metadata MD_C by copying the metadata MD_O of the file system FS. In an implementation, the metadata MD_C may include mapping information between a file offset and a logical address. For example, the metadata MD_C may include an extent status tree. The metadata MD_C may further include a version number. The metadata MD_C may be stored in the host memory 1120.

In operation S530, the offloading manager 1111 may transmit a first adaptive read request A_READ1 to the storage device 1200. In an implementation, the first adaptive read request A_READ1 may include an address of the host memory 1120 in which the metadata MD_C is stored. In an implementation, the first adaptive read request A_READ1 may include a version number.

In an implementation, the adaptive read request may further include a data page address, a scratch page address, a Berkeley packet filter (BPF) program address, a parallel field, an EXT4 inode operation field, and the like. For example, the data page address may indicate an address of the host memory 1120 in which read data is to be stored. The scratch page address may indicate an address of a scratch page used for a parallel second offloading operation. The scratch page address may indicate an address of the host memory 1120 to be stored. The BPF program address may indicate an address of the host memory 1120 in which the eBPF program is stored. The parallel field may indicate a request for a parallel second offloading operation. For example, a parallel field having an activation value may indicate a parallel second offloading operation, and a parallel field having a deactivation value may indicate a second offloading operation. The EXT4 inode operation field may be a field for identifying whether a direct map is used.

In operation S540, the offloading manager 1111 may determine whether a reverse offloading request has been received. The offloading manager 1111 may receive a response including a reverse offloading field indicating an activation value. The offloading manager 1111 may perform the operation of operation S550 when receiving the reverse offloading request, and may perform the operation of operation S570 when the reverse offloading request is not received.

In operation S550, the offloading manager 1111 may perform the first offloading operation. The offloading manager 1111 may receive the first read data RD1. The offloading manager 1111 may generate a second address ADDR2 based on the metadata MD_C and the first read data RD1. The offloading manager 1111 may calculate a file offset based on the first read data RD1 and convert the file offset into a second logical address based on the metadata MD_C.

In operation S560, the offloading manager 1111 may transmit a second adaptive read request A_READ2 to the storage device 1200. The offloading manager 1111 may transmit, to the storage device 1200, a second adaptive read request A_READ2 including a second logical address.

In operation S570, the offloading manager 1111 may receive the second read data RD2. The offloading manager 1111 may receive a second response REP2 corresponding to the second read data RD2. The offloading manager 1111 may receive a second response REP2 including a reverse offloading field indicating a deactivation value. For example, the reverse offloading field indicating a deactivation value may indicate the end of the read offloading operation.

In operation S580, the offloading manager 1111 may perform a validation operation. The offloading manager 1111 may perform the validation operation to ensure the validity of the metadata MD_C. The offloading manager 1111 may perform the validation operation based on the metadata original and the metadata copy.

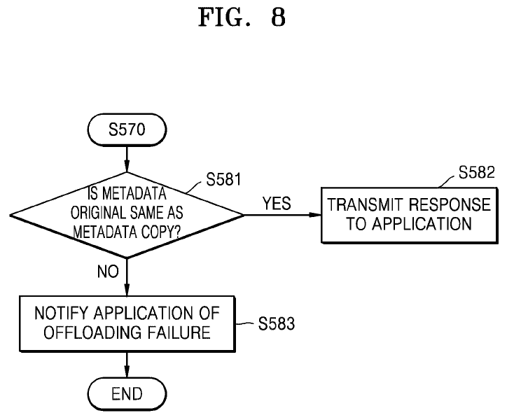

FIG. 8 is a flowchart illustrating operation S580 of FIG. 7 in more detail according to an implementation.

Referring to FIGS. 1, 7, and 8, the offloading manager 1111 may perform a validation operation. The first offloading operation and the second offloading operation may be performed based on the metadata MD_C. The metadata MD_C may be data obtained by copying the metadata MD_O managed in the file system FS. Accordingly, when the file content is changed, the metadata MD_C is invalidated, and thus the result of the read offloading operation may not be valid.

The offloading manager 1111 may check whether the metadata MD_O of the file system FS remains unchanged from the time when the metadata MD_C is copied until the adaptive read request (or read offloading request) is completed. Accordingly, the offloading manager 1111 may ensure the validity of the metadata MD_C. The offloading manager 1111 may ensure the validity of the extent state tree while performing the read offloading operation.

In an implementation, the offloading manager 1111 may perform a validation operation based on the version number included in the metadata MD_C. Alternatively, the offloading manager 1111 may perform a validation operation based on the version number included in the second response REP2.

In operation S581, the offloading manager 1111 may determine whether the metadata original is the same as the metadata copy. The offloading manager 1111 may compare the metadata original with the metadata copy. Here, the metadata original may indicate the metadata MD_O managed by the file system FS, and the metadata copy may indicate the metadata MD_C managed by the offloading manager 1111.

The offloading manager 1111 may perform the operation of operation S582 when it is determined that the metadata original is the same as the metadata copy, and may perform the operation of operation S583 when it is determined that the metadata original is different from the metadata copy.

In an implementation, the offloading manager 1111 may determine whether the metadata original is the same as the metadata copy based on the version number included in the metadata original and the version number included in the metadata copy. The offloading manager 1111 may compare the version number included in the metadata original with the version number included in the metadata copy (or the version number included in the response). When the version number included in the metadata original is the same as the version number included in the metadata copy, the offloading manager 1111 may determine that the metadata original is the same as the metadata copy. When the version number included in the metadata original is different from the version number included in the metadata copy, the offloading manager 1111 may determine that the metadata original is different from the metadata copy.

In operation S582, the offloading manager 1111 may transmit the read offloading response R_OFF_REP to the application APP. For example, the read offloading response R_OFF_REP may include a status field indicating a read offloading success. Since the metadata original is the same as the metadata copy, the offloading manager 1111 may determine that the result of the read offloading operation is valid. The offloading manager 1111 may transmit the result of the read offloading operation to the application APP.

In operation S583, the offloading manager 1111 may notify the application APP of a read offloading failure. For example, the offloading manager 1111 may transmit, to the application APP, a read offloading response including a status field indicating the read offloading failure. Since the metadata original is different from the metadata copy, the offloading manager 1111 may determine that the result of the read offloading operation is invalid. The offloading manager 1111 may notify the application APP that the read offloading has failed. However, implementations are not limited thereto.

In an implementation, the offloading manager 1111 may re-perform the read offloading operation instead of notifying the application APP of the read offloading failure. The offloading manager 1111 may recreate the metadata MD_C based on the metadata (i.e., updated metadata) managed by the file system FS. The offloading manager 1111 may transmit an adaptive read request to the storage device 1200 again based on the updated metadata MD_C. For example, the offloading manager 1111 may retry the read offloading operation based on the updated metadata MD_C.

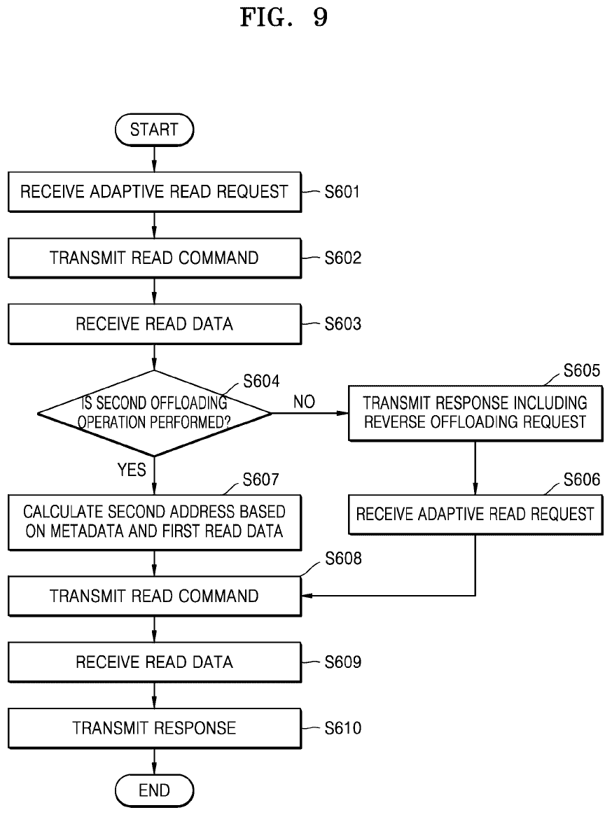

FIG. 9 is a flowchart illustrating an example of a method of operating the storage controller of FIG. 1 according to an implementation.

Referring to FIGS. 1 and 9, the storage controller 1210 may process an adaptive read request. The storage controller 1210 may perform a second offloading operation. When the operation resources are insufficient, the storage controller 1210 may perform reverse offloading.

In operation S601, the storage controller 1210 may receive an adaptive read request. For example, the storage controller 1210 may receive a first adaptive read request A_READ1. The first adaptive read request A_READ1 may include a first address ADDR1 and an address of the host memory 1120 in which the metadata MD_C is stored. The storage controller 1210 may receive the metadata MD_C. Alternatively, the storage controller 1210 may read the metadata MD_C from the address of the host memory 1120.

In operation S602, the storage controller 1210 may transmit a read command to the nonvolatile memory device 1220. For example, the storage controller 1210 may transmit, based on the adaptive read request, the first read command R_CMD1 to the nonvolatile memory device 1220. The first read command R_CMD1 may include a first physical address PADDR1 corresponding to the first address ADDR1.

In operation S603, the storage controller 1210 may receive read data from the nonvolatile memory device 1220. The storage controller 1210 may receive the first read data RD1 corresponding to the first physical address PADDR1.

In operation S604, the storage controller 1210 may determine whether to perform the second offloading operation. The storage controller 1210 may determine whether to perform the second offloading operation based on an internal resource. The storage controller 1210 may determine whether operation resources are sufficient. When the operation resources are sufficient, the storage controller 1210 may determine to perform the second offloading operation. When the operation resources are insufficient, the storage controller 1210 may determine to perform reverse offloading. When it is determined to perform the second offloading operation, the storage controller 1210 may perform the operation of operation S607 and when it is determined not to perform the second offloading operation (i.e., when it is determined to perform the reverse offloading), the storage controller 1210 may perform the operation of operation S605.

In an implementation, when a core in an idle state exists, the storage controller 1210 may determine to perform the second offloading operation. When the core in the idle state does not exist, the storage controller 1210 may determine to perform reverse offloading.

In operation S605, the storage controller 1210 may transmit, to the host device 1100, a response including a reverse offloading field indicating an activation value. In an implementation, the storage controller 1210 may transmit the first read data RD1 to the host device 1100. For example, the storage controller 1210 may write the first read data RD1 to a data page address included in the first adaptive read request A_READ1. The data page address may indicate an address of the host memory 1120. The storage controller 1210 may transmit a first response REP1 including the reverse offloading request to the offloading manager 1111.

In operation S606, the storage controller 1210 may receive an adaptive read request. For example, the storage controller 1210 may receive a second adaptive read request A_READ2 including a second address ADDR2. The second address ADDR2 may be generated by the offloading manager 1111.

In operation S607, the storage controller 1210 may calculate the second address based on metadata and read data. The storage controller 1210 may generate the second address ADDR2 based on the metadata MD_C and the first read data RD1. For example, the storage controller 1210 may calculate a file offset based on the first read data RD1. The storage controller 1210 may convert the file offset into the second address ADDR2 based on the metadata MD_C.

In operation S608, the storage controller 1210 may transmit a read command to the nonvolatile memory device 1220. For example, the storage controller 1210 may transmit, to the nonvolatile memory device 1220, a second read command R_CMD2 including a second physical address PADDR2 corresponding to the second address ADDR2.

In operation S609, the storage controller 1210 may receive read data. The storage controller 1210 may receive, from the nonvolatile memory device 1220, the second read data RD2 corresponding to the second physical address PADDR2.

In operation S610, the storage controller 1210 may transmit a response to the host device 1100. The storage controller 1210 may transmit the second read data RD2 to the host device 1100. The storage controller 1210 may write the second read data RD2 to a data page address included in the most recently received adaptive read request. The data page address may indicate an address of the host memory 1120. The storage controller 1210 may transmit, to the offloading manager 1111, a response including a reverse offloading field indicating a deactivation value. Alternatively, the storage controller 1210 may transmit, to the offloading manager 1111, a response including an termination field indicating termination. For example, the termination field may be a field for distinguishing whether the termination field means a real completion or requires a first offloading operation.

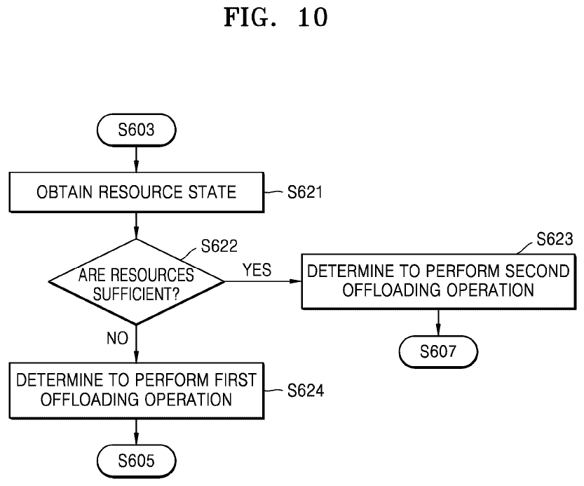

FIG. 10 is a flowchart illustrating operation S604 of FIG. 9 in more detail according to an implementation.

Referring to FIGS. 1, 9, and 10, operation S604 may include operations S621 to S624. In operation S621, the storage controller 1210 may acquire a resource state. The resource state may be used as a reference for determining whether the second offloading operation is performed. For example, the storage controller 1210 may acquire an operation resource state. The operation resource may include one or more cores or processors. For example, the resource state may be an operation resource state. Specifically, the resource state may include state information indicating whether the core is in an idle state or a busy state (or is in operation). The resource state may include information indicating the utilization rates or loads of the cores. The resource state may include the length of the task queue allocated to the core (or the number of tasks (or requests) stored in the queue).

In operation S622, the storage controller 1210 may determine whether resources are sufficient. In an implementation, the storage controller 1210 may determine whether the operation resources are sufficient based on the operation resource state. For example, the storage controller 1210 may determine whether there are sufficient operation resources to perform the second offloading operation. The storage controller 1210 may determine whether a core in an idle state exists among a plurality of cores. The storage controller 1210 may perform the operation of operation S623 when the operation resources are sufficient, and may perform the operation of operation S624 when the operation resources are insufficient.

In operation S623, the storage controller 1210 may determine to perform the second offloading operation. Since the storage controller 1210 has sufficient operation resources, it may be determined to perform the second offloading operation inside the storage controller 1210.

In operation S624, the storage controller 1210 may determine to perform reverse offloading. The storage controller 1210 may determine to perform the first offloading operation. Since the storage controller 1210 has insufficient operation resources, it may be determined not to perform the second offloading operation. The storage controller 1210 may determine to perform the reverse offloading operation.

As described above, the storage controller 1210 may determine whether to perform the second offloading operation based on the operation resource state. For example, when the core or processor is in an overload state, the storage controller 1210 may perform reverse offloading to prevent an increase in latency.

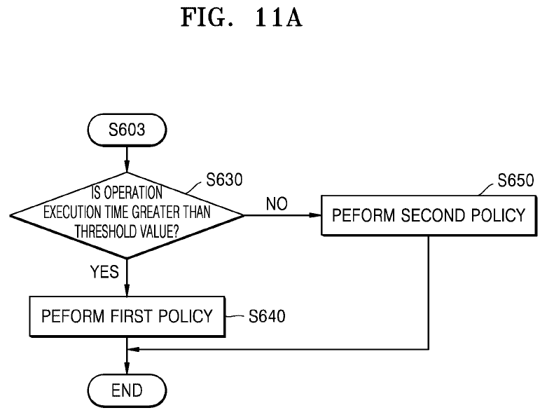

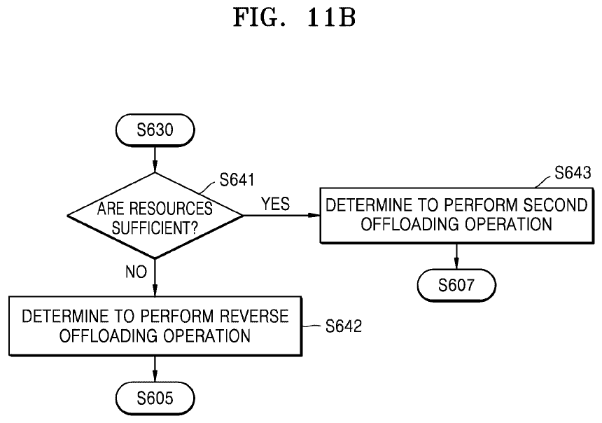

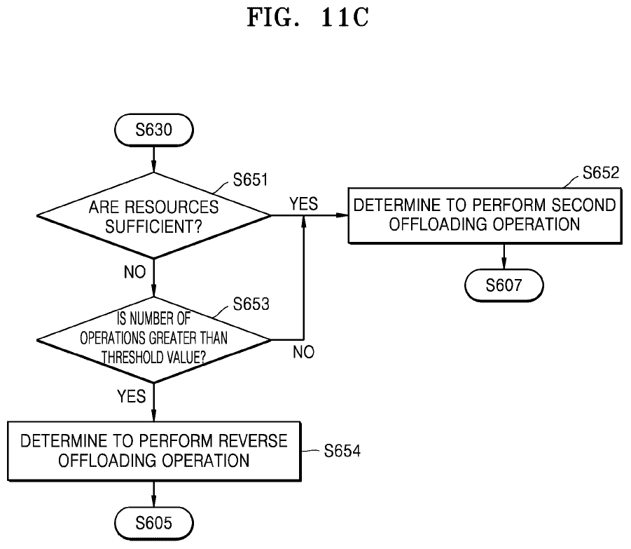

FIG. 11A is a flowchart illustrating operation S604 of FIG. 9 in more detail according to an implementation. FIG. 11B is a flowchart illustrating operation S640 of FIG. 11A in more detail according to an implementation. FIG. 11C is a flowchart illustrating operation S650 of FIG. 11A in more detail according to an implementation.

Referring to FIGS. 1, 9, and 11A, operation S604 may include operations S630 to S650. The storage controller 1210 may determine a reverse offloading policy based on the operation execution time. For example, the reverse offloading policy may include a first policy and a second policy. The first policy may indicate a policy for an operation in which the operation execution time is greater than a first threshold value. The second policy may indicate a policy for an operation in which the operation execution time is equal to or less than the first threshold value.

In operation S630, the storage controller 1210 may compare the operation execution time with a threshold value. The storage controller 1210 may determine whether the execution time of the second offloading operation is greater than the first threshold value. The execution time of the second offloading operation may be determined or predicted in advance. The first threshold value may be a predetermined value. The first threshold may be adjusted. The storage controller 1210 may perform the operation of operation S640 when the operation execution time is greater than the first threshold value, and may perform the operation of operation S650 when the operation execution time is less than or equal to the first threshold value.

In operation S640, the storage controller 1210 may perform a first policy. For example, the first policy may be a policy for an operation having a relatively long operation execution time. The first policy may be a reverse offloading priority policy. For example, the first policy may be a policy for determining whether to perform the second offloading operation based only on the presence or absence of a core in an idle state.

In operation S650, the storage controller 1210 may perform a second policy. For example, the second policy may be a policy for an operation having a relatively short operation execution time. The second policy may be a second offloading priority policy. For example, the second policy may be a policy for determining whether to perform the second offloading operation based on the number of tasks assigned to the core, even if there is no idle core.

Referring to FIG. 11B, operation S640 may include operations S641 to S643. In operation S641, the storage controller 1210 may determine whether resources are sufficient. The storage controller 1210 may perform the operation of operation S643 when the resources are sufficient, and may perform the operation of operation S642 when the resources are insufficient.

In operation S642, the storage controller 1210 may determine to perform reverse offloading. Since the storage controller 1210 has insufficient resources, it may be determined not to perform the second offloading operation. The storage controller 1210 may determine to perform reverse offloading so that the first offloading operation is performed by the offloading manager 1111 to prevent the latency from increasing. Thereafter, the storage controller 1210 may perform an operation of operation S605 of FIG. 9.

In operation S643, the storage controller 1210 may determine to perform the second offloading operation. Since the storage controller 1210 has sufficient resources, it may be determined to perform the second offloading operation. Thereafter, the storage controller 1210 may perform an operation of operation S607 of FIG. 9.

Referring to FIG. 11C, operation S650 may include operations S651 to S654. In operation S651, the storage controller 1210 may determine whether resources are sufficient. The storage controller 1210 may perform the operation of operation S652 when the resources are sufficient, and may perform the operation of operation S653 when the resources are insufficient.

In this configuration, the storage controller 1210 may determine that resources are sufficient when available cores exist. The storage controller 1210 may determine that resources are sufficient when there is a core to which a task is not assigned. The storage controller 1210 may determine that resources are sufficient when a core waiting for operation exists.

In operation S652, the storage controller 1210 may determine to perform the second offloading operation. Since the storage controller 1210 has sufficient resources, it may be determined to perform the second offloading operation. Thereafter, the storage controller 1210 may perform an operation of operation S607 of FIG. 9.

In operation S653, the storage controller 1210 may compare the number of tasks with a second threshold value. The second threshold value may be a predetermined value. The second threshold may be adjusted. The storage controller 1210 may determine whether the number of tasks allocated to the core is greater than the second threshold value. The storage controller 1210 may perform the operation of operation S654 when the number of tasks is greater than the second threshold value, and may perform the operation of operation S652 when the number of tasks is equal to or less than the second threshold value. The storage controller 1210 may determine to perform the second offloading operation based on the determination that the number of tasks is equal to or less than the second threshold value. Based on the determination that the number of tasks is greater than the second threshold, the storage controller 1210 may determine not to perform the second offloading operation (i.e., may determine to perform reverse offloading).

In operation S654, the storage controller 1210 may determine to perform reverse offloading. Since the storage controller 1210 has insufficient resources, it may be determined not to perform the second offloading operation. When resources are insufficient and the number of tasks is large, the storage controller 1210 may determine to perform reverse offloading so that the first offloading operation is performed by the offloading manager 1111 to prevent an increase in latency. Thereafter, the storage controller 1210 may perform an operation of operation S605 of FIG. 9.

The storage controller 1210 may have relatively low operation capabilities compared to the host controller 1110. The storage controller 1210 may dynamically perform a second offloading operation. For example, the storage controller 1210 may determine whether to perform the second offloading operation based on whether the operation resource is available. The storage controller 1210 may perform a second offloading operation when there is a spare operation resource, and may perform a reverse offloading operation when there is no spare operation resource. Accordingly, it is possible to prevent an increase in latency due to a lack of operation resources of the storage device 1200.

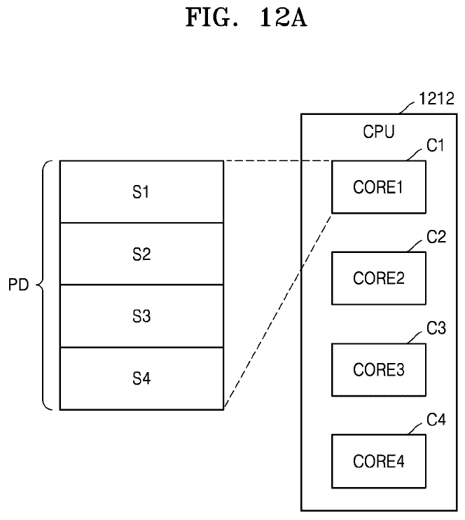

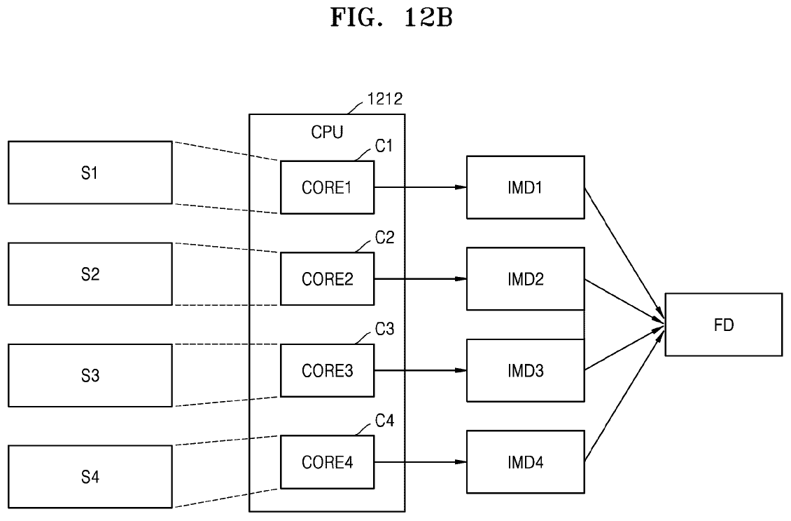

FIGS. 12A and 12B are diagrams respectively illustrating operations of the storage system of FIG. 1 according to an implementation.

Referring to FIGS. 1 and 12A, a CPU 1212 may include a plurality of cores C1 to C4. For example, the offloading operation may be a search operation within page data. The page data PD may include first to fourth regions S1 to S4. The storage system 1000 may perform a read offloading operation. The storage device 1200 may perform a second offloading operation. In an implementation, the first core C1 may perform a second offloading operation. The first core C1 may perform a search operation on the entire page data PD. For example, the first core C1 may perform a search operation on all of the first to fourth regions S1 to S4.

Referring to FIGS. 1 and 12B, the storage device 1200 may receive an adaptive read request including a parallel field indicating an activation value. Based on an adaptive read request including a parallel field indicating an activation value, the storage device 1200 may perform a parallel second offloading operation by the plurality of cores C1 to C4. For example, when the resources are insufficient, the storage device 1200 may perform reverse offloading, and when the resources are sufficient, the storage device 1200 may perform a second offloading operation by the plurality of cores C1 to C4.

For example, the first core C1 may perform a search operation on the first region S1, the second core C2 may perform a search operation on the second region S2, the third core C3 may perform a search operation on the third region S3, and the fourth core C4 may perform a search operation on the fourth region S4. The first core C1 may generate first intermediate data IMD1 which is an operation result for the first region S1. The second core C2 may generate second intermediate data IMD2 which is an operation result for the second region S2. The third core C3 may generate third intermediate data IMD3 which is an operation result for the third region S3. The fourth core C4 may generate fourth intermediate data IMD4 which is an operation result for the fourth region S4.

Hereinafter, it is assumed that the first core C1 of the first to fourth cores C1 to C4 is a main core (or a leader core). The first core C1, which is the main core, may generate final data FD based on the first to fourth intermediate data IMD1 to IMD4. The final data FD may be the same as the operation result for the entire page data PD with only the first core C1 in FIG. 12A.

The storage system 1000 may perform a parallel second offloading operation using a plurality of eBPFs. The host device 1100 may transmit the plurality of eBPFs to the storage device 1200. Each of the plurality of cores C1 to C4 may perform a re-submission operation in parallel through a corresponding eBPF. For example, each of the plurality of cores C1 to C4 may perform the second offloading operation in parallel through the corresponding eBPF.

In an implementation, the parallel second offloading operation may indicate an operation of performing, by the plurality of cores C1 to C4, an offset operation for a subsequent read operation in parallel based on read data of a previous read operation. For example, each of the plurality of cores C1 to C4 may receive a portion of the page data PD. The page data PD1 may be first read data RD1 which is a result of the first read operation. Each of the plurality of cores C1 to C4 may receive a corresponding area and search for a file offset corresponding to a subsequent read operation in the area. Each of the plurality of cores C1 to C4 may convert a file offset into a logical address. Each of the plurality of cores C1 to C4 may generate a result thereof. For example, each of the plurality of cores C1 to C4 may generate corresponding intermediate data.

In an implementation, each of the plurality of cores C1 to C4 may write a result thereof on a scratch page. For example, the scratch page may indicate an address of the host memory 1120. However, implementations are not limited thereto, and the scratch page may indicate an address of the buffer memory 1214. The address of the scratch page may be included in the adaptive read request. Alternatively, the metadata MD_C may include the address of the scratch page. Alternatively, the adaptive read request may include the address of the host memory 1120 in which the auxiliary data is stored. The auxiliary data may include the address of the scratch page. For example, the scratch page may include first to fourth scratch pages.

For example, the first core C1 may write the first intermediate data IMD1 on the first scratch page, the second core C2 may write the second intermediate data IMD2 on the second scratch page, the third core C3 may write the third intermediate data IMD3 on the third scratch page, and the fourth core C4 may write the fourth intermediate data IMD4 on the fourth scratch page. The first core C1 previously designated as the main core may copy the first to fourth intermediate data IMD1 to IMD4 to write the final data FD to a fifth scratch page.

As described above, the storage device 1200 may perform a parallel second offloading operation. The operation execution time (or execution time) may be reduced through operation parallelization.

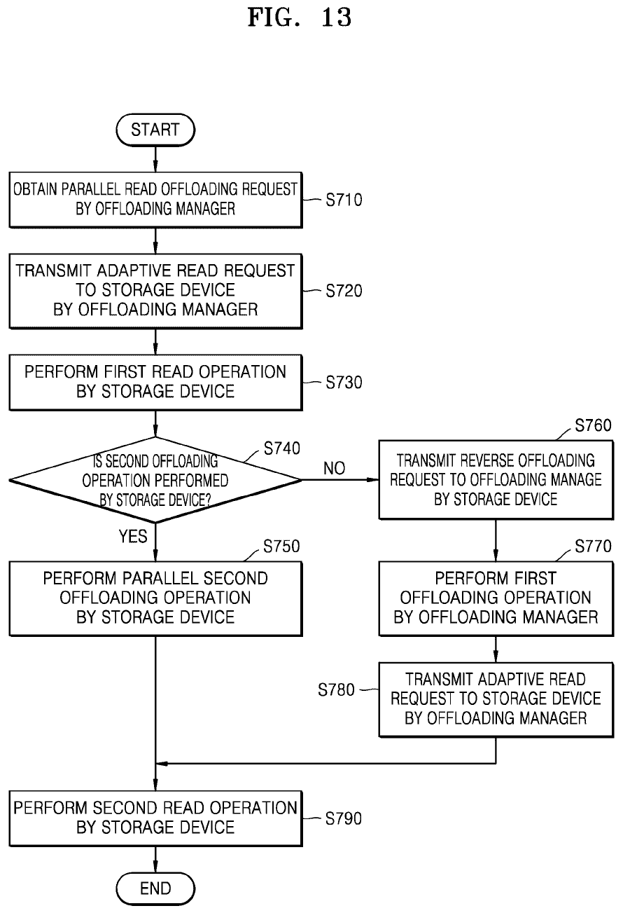

FIG. 13 is a flowchart illustrating an example of a method of operating the storage system of FIG. 1 according to an implementation.

Referring to FIGS. 1 and 13, the storage system 1000 may perform a parallel hybrid read offloading operation. In operation S710, the offloading manager 1111 may obtain a parallel read offloading request. The application APP may transmit a parallel read offloading request to the offloading manager 1111. In an implementation, the application APP may transmit the parallel read offloading request to the offloading manager 1111 by using a system call. The parallel read offloading request may be a type of system call. For example, the parallel read offloading request R_OFF_REQ may be read_sode_parallel().

In operation S720, the offloading manager 1111 may transmit an adaptive read request to the storage device 1200. The offloading manager 1111 may transmit, to the storage device 1200, a first adaptive read request including a parallel field indicating an activation value. The first adaptive read request may include a first address and an address of the host memory 1120 in which the metadata MD_C is stored.

In operation S730, the storage device 1200 may perform a first read operation. The storage controller 1210 may convert the first address ADDR1 to the first physical address PADDR1 in response to the first adaptive read request A_READ1. The storage controller 1210 may transmit, to the nonvolatile memory device 1220, a first read command R_CMD1 including a first physical address PADDR1. The nonvolatile memory device 1220 may transmit, to the storage controller 1210, the first read data RD1 corresponding to the first physical address PADDR1.

In operation S740, the storage device 1200 may determine whether to perform the second offloading operation. The storage device 1200 may determine whether to perform the second offloading operation based on the internal resource. When it is determined to perform the second offloading operation, the storage system 1000 may perform the operation of operation S750, and when it is determined not to perform the second offloading operation (i.e., when it is determined to perform the reverse offloading operation), the storage system 1000 may perform the operation of operation S760.

In operation S750, the storage device 1200 may perform a parallel second offloading operation. The storage device 1200 may perform a parallel second offloading operation based on the metadata MD_C and the first read data RD1. For example, the storage device 1200 may calculate a file offset based on the first read data RD1. The plurality of cores may calculate, in parallel, a file offset to be used in a subsequent read operation based on the first read data RD1. Latency may be reduced by performing an operation with the plurality of cores. The storage device 1200 may convert the file offset into a logical address based on the metadata MD_C. The storage device 1200 may generate a second address ADDR2. After operation S750, the storage system 1000 may perform an operation of operation S790.

In operation S760, the storage device 1200 may transmit a reverse offloading request to the offloading manager 1111. In operation S770, the offloading manager 1111 may perform the first offloading operation. In operation S780, the offloading manager 1111 may transmit an adaptive read request to the storage device 1200. The offloading manager 1111 may transmit, to the storage device 1200, a second adaptive read request A_READ2 including a second address ADDR2. After operation S780, the storage system 1000 may perform an operation of operation S190 of FIG. 4. In operation S790, the storage device 1200 may perform a second read operation. operations S760 to S790 are the same as or similar to operations S160 to S190 of FIG. 4, and thus a detailed description thereof is omitted.

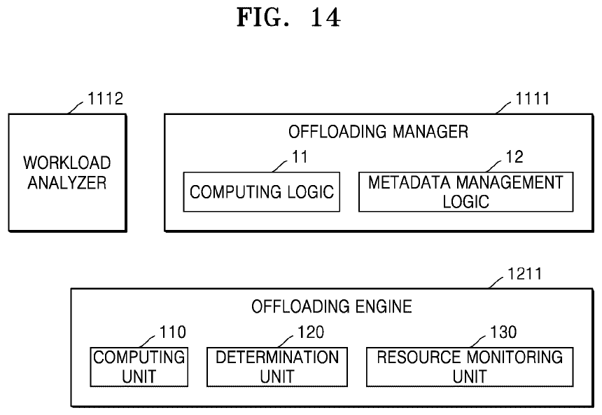

FIG. 14 is a block diagram illustrating in more detail a workload analyzer, an offloading manager, and an offloading engine according to an implementation.

Referring to FIGS. 1, 3, and 14, the host controller 1110 may include an offloading manager 1111 and a workload analyzer 1112. The offloading manager 1111 may include a computing logic 11 and a metadata management logic 12. The offloading engine 1211 may include a computing unit 110, a determination unit 120, and a resource monitoring unit 130. For convenience of description, detailed descriptions of the components described above are omitted.

The workload analyzer 1112 may analyze the workload of the application APP. In an implementation, the workload analyzer 1112 may statically analyze the workload. In an implementation, the workload analyzer 1112 may dynamically analyze the workload. For example, the workload analyzer 1112 may extract workload characteristics by monitoring data access (or input/output) between the application APP and the storage device 1200. The workload analyzer 1112 may detect and analyze a data access pattern. The workload analyzer 1112 may monitor requests (or commands) and data between the application APP and the storage device 1200. The workload analyzer 1112 may extract workload characteristics based on the monitoring result.

In an implementation, the workload characteristics may include a data-dependent read pattern. However, implementations are not limited thereto, and workload characteristics may further include at least one of read intensive, write intensive, read ratio, workload size, work set size, cache status information (e.g., hit rate), and workflow.

In an implementation, the workload analyzer 1112 may determine whether the workload is a data-dependent read pattern (or a data-dependent access pattern). The data-dependent read pattern may include at least two read operations, and the subsequent read operation may indicate a data access pattern performed based on a result of the previous read operation. In other words, the data-dependent read pattern may include a first read operation and a second read operation, and a second address corresponding to the second read operation may indicate a data access pattern calculated based on the first read data corresponding to the first read operation.

In an implementation, the workload analyzer 1112 may transmit workload characteristics to the offloading manager 1111 or the application APP. The workload analyzer 1112 may inform the offloading manager 1111 or the application APP that the workload is a data-dependent read pattern. The storage system 1000 may perform a read offloading operation or a parallel read offloading operation based on the workload characteristics being a data-dependent read pattern.

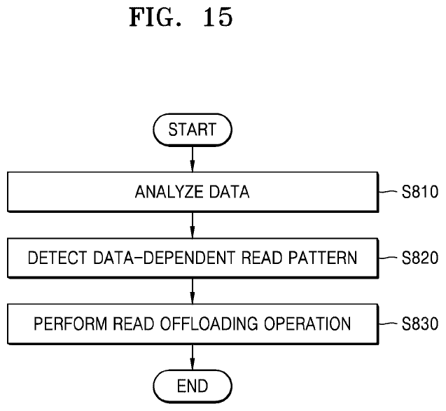

FIG. 15 is a flowchart illustrating an example of a method of operating the storage system of FIG. 1 according to an implementation.

Referring to FIGS. 1, 14, and 15, in operation S810, the storage system 1000 may analyze a data access pattern. For example, the storage system 1000 may perform one of workload static analysis and/or dynamic analysis. The storage system 1000 may monitor the data access pattern of the workload between the application APP and the storage device 1200.

In operation S820, the storage system 1000 may detect that the workload is a data-dependent read pattern. The storage system 1000 may determine that the workload is a data-dependent read pattern based on the result of the static analysis or the result of the dynamic analysis. The storage system 1000 may determine whether a workload is required to access the storage device at least two-times (e.g., a first read operation and a second read operation), and the second read operation is performed based on the result of the first read operation.

In an implementation, the workload analyzer 1112 may notifies the offloading manager 1111 or the application APP that the workload is a data-dependent read pattern.

In operation S830, the storage system 1000 may perform a read offloading operation. The storage system 1000 may perform a read offloading operation to perform at least one of the first offloading operation and the second offloading operation. The storage system 1000 may process workloads through a read offloading operation.

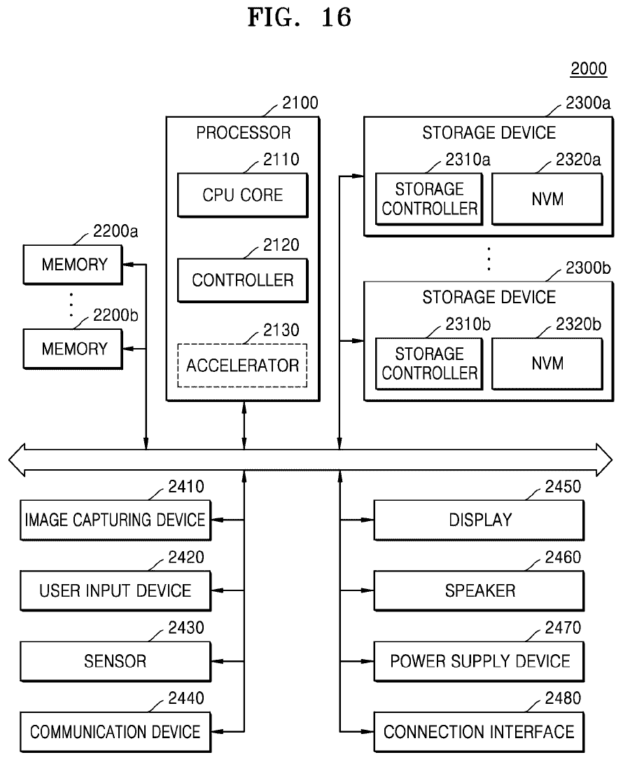

FIG. 16 is a diagram of a system according to an implementation.

Referring to FIG. 16, a system 2000 may include a main processor 2100, memories 2200a and 2200b, and storage devices 2300a and 2300b, and may further include at least one of an image capturing device 2410, a user input device 2420, a sensor 2430, a communication device 2440, a display 2450, a speaker 2460, a power supply device 2470, and a connection interface 2480.

The main processor 2100 may control the overall operation of the system 2000, more specifically, the operation of other components constituting the system 2000. Such a main processor 2100 may be implemented as a general-purpose processor, a dedicated processor, an application processor, or the like.

The main processor 2100 may include one or more CPU cores 2110, and may further include a controller 2120 for controlling the memories 2200a and 2200b and/or the storage devices 2300a and 2300b. Depending on the implementation, the main processor 2100 may further include an accelerator 2130, which is a dedicated circuit for high-speed data operation such as artificial intelligence (AI) data operation. The accelerator 2130 may include a graphics processing unit (GPU), a neural processing unit (NPU), and/or a data processing unit (DPU), and may be implemented as a separate chip physically independent of other components of the main processor 2100.

The memories 2200a and 2200b may be used as main memory devices of the system 2000, and may include volatile memories such as SRAM and/or DRAM, but may also include nonvolatile memories such as flash memory, FRAM, PRAM and/or RRAM. The memories 2200a and 2200b may be implemented in the same package as the main processor 2100.

The storage devices 2300a and 2300b may function as nonvolatile storage devices that store data regardless of whether power is supplied or not, and may have a relatively large storage capacity compared to the memories 2200a and 2200b. The storage devices 2300a and 2300b may include storage controllers 2310a and 2310b and nonvolatile memories (NVMs) 2320a and 2320b that store data under the control by the storage controllers 2310a and 2310b. The nonvolatile memories 2320a and 2320b may include flash memories of a 2D structure or a 3D vertical NAND (V-NAND) structure, but may also include other types of nonvolatile memories such as PRAM and/or RRAM.

The storage devices 2300a and 2300b may be included in the system 2000 in a state of being physically separated from the main processor 2100, or may be implemented in the same package as the main processor 2100. In some implementations, the storage devices 2300a and 2300b may be detachably combined with other components of the system 2000 through an interface such as a connection interface 2480 to be described later by having a form such as a solid state device (SSD) or a memory card. Such storage devices 2300a and 2300b may be devices to which standard protocols such as UFS, eMMC, or nonvolatile memory express (NVMe) are applied, but are not limited thereto.

The image capturing device 2410 may photograph a still image or a moving image, and may be a camera, a camcorder, a webcam, or the like.

The user input device 2420 may receive various types of data input from the user of the system 2000, and may be a touch pad, a keypad, a keyboard, a mouse, and/or a microphone.

The sensor 2430 may detect various types of physical quantities that may be obtained from the outside of the system 2000 and convert the sensed physical quantities into electrical signals. The sensor 2430 may be a temperature sensor, a pressure sensor, an illumination sensor, a position sensor, an acceleration sensor, a biosensor, a gyroscope sensor, or the like.

The communication device 2440 may transmit and receive signals with respect to other devices outside the system 2000 according to various communication protocols. Such a communication device 2440 may be implemented by including an antenna, a transceiver, and/or a modulation/demodulation unit (modem).

The display 2450 and the speaker 2460 may function as output devices that output visual information and auditory information to the user of the system 2000, respectively.

The power supply device 2470 may appropriately convert power supplied from a battery embedded in the system 2000 and/or an external power source and supply the converted power to each component of the system 2000.

The connection interface 2480 may provide a connection between the system 2000 and an external device connected to the system 2000 to exchange data with the system 2000. The connecting interface 2480 may be implemented in a variety of interface methods such as Advanced Technology Attachment (ATA), Serial ATA (SATA), External SATA (e-SATA), Small Computer Small Interface (SCSI), Serial Attached SCSI (SAS), Peripheral Component Interconnection (PCI), PCI express (PCIe), NVMe, IEEE 1394, universal serial bus (USB), Secure Digital (SD) card interface, MMC, eUFS, Compact Flash (CF) card interface, and the like.

In an implementation, the processor 2100 may be the host controller 1110 described with reference to FIGS. 1 to 15, the memories 2200a and 2200b may be the host memory 1120 described with reference to FIGS. 1 to 15, and the storage devices 2300a and 2300b may be the storage device 1200 described with reference to FIGS. 1 to 15. The system 2000 may perform a read offloading operation and a parallel read offloading operation based on the method described with reference to FIGS. 1 to 15. The storage devices 2300a and 2300b may perform a second offloading operation, a reverse offloading operation, and a parallel second offloading operation. The processor 2100 may perform a first offloading operation. Accordingly, the operation load of the host controller 1110 may be distributed and latency may be reduced. In some implementations, when internal resources of the storage devices 2300a and 2300b are insufficient, reverse offloading may be performed to prevent an increase in latency. The system 2000 with improved performance is provided.

While the present disclosure contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the present disclosure has been particularly shown and described with reference to implementations thereof, it will be understood that various changes in form and details may be made therein without departing from the spirit and scope of the following claims.

What is claimed is:

1. A method of operating a storage system including a host device and a storage device, the host device including an offloading manager, the method comprising:
receiving, by the offloading manager, a read offloading request for a workload with a data-dependent read pattern;
transmitting, by the offloading manager, a first adaptive read request including metadata and a first address to the storage device based on the read offloading request;
performing, by the storage device, a first read operation corresponding to the first address based on the first adaptive read request;
based on a determination, by the storage device, to perform a second offloading operation based on an internal resource, generating a second address based on the metadata and first read data that is a result of the first read operation, and performing a second read operation corresponding to the second address; and
based on a determination, by the storage device, not to perform the second offloading operation based on the internal resource, transmitting, to the offloading manager, a first response including a reverse offloading field indicating an activation value.

2. The method of claim 1, comprising:
based on the first response including the reverse offloading field indicating the activation value, generating, by the offloading manager, a second address based on the metadata and the first read data, and transmitting a second adaptive read request including the second address to the storage device; and
performing, by the storage device, a second read operation corresponding to the second address based on the second adaptive read request.

3. The method of claim 1, comprising generating the metadata by copying original metadata of a file system by the offloading manager.

4. The method of claim 1, wherein the metadata of the first adaptive read request includes an extent status tree.

5. The method of claim 4, comprising:
transmitting, to the host device by the storage device, second read data corresponding to the second read operation;
transmitting, to the host device by the storage device, a second response including the reverse offloading field indicating a deactivation value; and
performing, by the offloading manager, a validation operation based on the second response.

6. The method of claim 5, wherein performing the validation operation comprises determining, by the offloading manager, that the metadata of the first adaptive read request is a same as metadata of a file system.

7. The method of claim 5, wherein performing the validation operation comprises determining, by the offloading manager, that a value of a version number field included in the second response is a same as a version number of a file system.

8. The method of claim 1, wherein determining, by the storage device, to perform the second offloading operation based on the internal resource comprises:
receiving an operation resource state;
determining sufficiency of an operation resource based on the operation resource state;
determining to perform the second offloading operation based on a determination that the operation resource is sufficient; and
determining not to perform the second offloading operation based on a determination that the operation resource is insufficient.

9. The method of claim 1, wherein determining, by the storage device, to perform the second offloading operation based on the internal resource comprises:
performing a first policy based on an operation performing time being greater than a first threshold; and
performing a second policy based on the operation performing time being equal to or less than the first threshold value.

10. The method of claim 9, wherein performing the first policy comprises:
determining to perform the second offloading operation based on a determination that operation resources are sufficient; and
determining not to perform the second offloading operation based on a determination that the operation resources are insufficient, and
wherein performing the second policy comprises:
determining to perform the second offloading operation based on the determination that the operation resources are sufficient;
determining a number of tasks assigned to a core with respect to a second threshold, based on the determination that the operation resources are insufficient;
determining not to perform the second offloading operation based on a determination that the number of tasks is greater than a second threshold value; and
determining to perform the second offloading operation based on a determination that the number of tasks is equal to or less than the second threshold value.

11. The method of claim 1, comprising:
receiving a parallel read offloading request by the offloading manager;
transmitting, to the storage device by the offloading manager, a third adaptive read request corresponding to the parallel read offloading request;
performing, by the storage device, a third read operation corresponding to a third address included in the third adaptive read request;
determining, by the storage device, to perform the second offloading operation based on the internal resource; and
performing a parallel second offloading operation by a plurality of cores included in the storage device,
wherein the third adaptive read request comprises a parallel field indicating an activation value, and the parallel second offloading operation indicates an operation of determining a file offset to be used for a subsequent read operation based on third read data that is a result of the third read operation in parallel by the plurality of cores.

12. The method of claim 1, comprising:
analyzing a data access pattern of a workload by a workload analyzer included in the host device;
detecting, by the workload analyzer, that the workload is a data-dependent read pattern; and
notifying an application or the offloading manager that the workload is the data-dependent read pattern by the workload analyzer.

13. A method of operating a storage controller, the method comprising:
receiving a first adaptive read request including a first address and an address of a host memory where metadata is stored;
reading the metadata from the address of the host memory;
transmitting a first read command corresponding to the first address to a nonvolatile memory device;
receiving first read data corresponding to the first read command from the nonvolatile memory device;
based on a determination to perform a second offloading operation based on an internal resource, generating a second address based on the metadata and the first read data and performing a second read operation corresponding to the second address;
based on a determination not to perform the second offloading operation based on the internal resource, transmitting, to a host device, a first response including a reverse offloading field indicating an activation value; and
transmitting, to the host device, a second response including a reverse offloading field indicating a deactivation value and a version number field indicating a version number of the metadata,
wherein the first adaptive read request is an offloading request for a workload having a data-dependent read pattern.

14. The method of claim 13, wherein the metadata includes an extent status tree.

15. The method of claim 13, wherein determining to perform the second offloading operation based on the internal resource comprises:
receiving an operation resource state;
determining sufficiency of an operation resource based on the operation resource state;
determining to perform the second offloading operation based on a determination that the operation resource is sufficient; and
determining not to perform the second offloading operation based on a determination that the operation resource is insufficient.

16. The method of claim 13, comprising:
receiving a third adaptive read request including a parallel field indicating an activation value;
performing a third read operation corresponding to a third address included in the third adaptive read request;
determining to perform the second offloading operation based on the internal resource; and
performing a parallel second offloading operation by a plurality of cores included in the storage controller,
wherein the parallel second offloading operation indicates an operation of determining a f ile offset to be used for a subsequent read operation based on third read data that is a result of the third read operation in parallel by the plurality of cores.

17. A storage system comprising:
a host device including an offloading manager; and
a storage device including a storage controller and a nonvolatile memory device,
wherein the offloading manager is configured to receive read offloading requests for workloads with data-dependent read patterns, and transmit a first adaptive read request including metadata and a first address to the storage device based on the read offloading requests, and
wherein the storage controller is configured to:
perform a first read operation corresponding to the first address based on the first adaptive read request;
based on a determination to perform a second offloading operation based on an internal resource, generate a second address based on the metadata and first read data that is a result of the first read operation, and perform a second read operation corresponding to the second address; and
based on a determination not to perform the second offloading operation based on the internal resource, transmit, to the offloading manager, a first response including a reverse offloading field indicating an activation value.

18. The storage system of claim 17,
wherein based on the first response including the reverse offloading field indicating the activation value, the offloading manager is configured to generate a second address based on the metadata and the first read data, and transmit a second adaptive read request including the second address to the storage device, and
wherein the storage controller is configured to perform a second read operation corresponding to the second address based on the second adaptive read request.

19. The storage system of claim 17,
wherein the storage controller is configured to transmit second read data corresponding to the second read operation to the host device, and transmit a second response including a reverse offloading field indicating a deactivation value to the host device, and
wherein the offloading manager is configured to perform a validation operation for determining that the metadata is a same as metadata of a file system based on the second response.

20. The storage system of claim 17,
wherein the host device comprises a workload analyzer, and
wherein the workload analyzer is configured to analyze a workload's data access pattern, detect that the workload is a data-dependent read pattern, and notify an application or the offloading manager that the workload is the data-dependent read pattern.
